(19) United States
(12) Patent Application Publication
(10) Pub. No.: US 2026/0099767 A1
(43) Pub. Date: Apr. 9, 2026

(54) Feedback-Based AI/ML Models Adaptation in Wireless Networks

(71) Applicant: Apple Inc., Cupertino, CA (US)

(72) Inventors: Ping-Heng KUO, London (GB); Naveen Kumar R PALLE VENKATA, San Diego, CA (US)

(21) Appl. No.: 19/113,768

(22) PCT Filed: Sep. 15, 2023
(86) PCT No.: PCT/US2023/032867

§ 371 Date: Mar. 20, 2025

Related U.S. Application Data
(60) Provisional application No. 63/376,644, filed on Sep. 22, 2022.

(51) Int. Cl. G06N 20/00; G06F 11/30

(52) U.S. Cl. CPC G06N 20/00; G06F 11/3006; G06F 11/3065

(57) ABSTRACT

An artificial intelligence (AI) agent configured to report a trained AI or machine learning (ML) (AI/ML) model to an AI manager, receive feedback from the AI manager regarding a performance of the trained AI/ML model and, based on the feedback, determining whether and how to improve a performance of the trained AI/ML model.

### PRIORITY/INCORPORATION BY REFERENCE

This application claims priority to U.S. Provisional Application Ser. No. 63/376,644 filed on Sep. 22, 2022 and entitled “Feedback-Based AI/ML Models Adaptation in Wireless Networks,” the entirety of which is incorporated herein by reference.

### BACKGROUND

5G New Radio (NR) has introduced many radio access network (RAN) and core network (CN) enhancements, as well as an enhanced security architecture. Artificial intelligence (AI) and/or machine learning (ML) processes, e.g., deep learning neural networks, may be used to facilitate and optimize certain decision makings in one or more network functionalities (e.g., in the RAN or CN). For example, the use cases for AI/ML for the air interface include channel state information (CSI) feedback enhancement (e.g., overhead reduction, improved accuracy, prediction); beam management (e.g., beam prediction in time, and/or spatial domain for overhead and latency reduction, beam selection accuracy improvement); and positioning accuracy enhancements. Additionally, the AI/ML services can be used by applications at the UE, the RAN, or external to the UE/RAN (e.g., AI-as-a-Service (AIaaS).

In any of these use cases, one or multiple UEs served by the RAN, or the RAN itself (e.g., a RAN node such as a gNB), can function as an AI agent that trains all or part of the AI/ML model(s). For example, a UE can train the model based on, e.g., data collected by the UE (e.g., radio-related measurements, application-related measurements, sensor input, etc.). In Federated Learning (FL) use cases, multiple UEs may report/transfer respective trained models to the RAN for model fusion/aggregation. Some FL applications include autonomous driving or autonomous railway.

In many scenarios, it is crucial to ensure that the trained AI/ML models meet a minimum required quality and can be trusted by the clients (e.g., network functions, UEs and/or external applications) using the AI/ML services. Particularly in FL use cases, if the training results from one AI agent do not meet the required quality, the aggregated global model may become misleading. For critical applications (e.g., autonomous driving), a poor quality AI/ML model can have disastrous effects.

### SUMMARY

Some exemplary embodiments are related to a processor of an artificial intelligence (AI) agent configured to perform operations. The operations include reporting a trained AI or machine learning (ML) (AI/ML) model to an AI manager, receiving feedback from the AI manager regarding a performance of the trained AI/ML model and based on the feedback, determining whether and how to improve a performance of the trained AI/ML model.

Other exemplary embodiments are related to a processor of an artificial intelligence (AI) manager configured to perform operations. The operations include receiving a trained AI or machine learning (ML) (AI/ML) model from an AI agent, evaluating a performance of the trained AI/ML model and providing feedback to the AI manager regarding the performance of the trained AI/ML model.

### BRIEF DESCRIPTION OF THE DRAWINGS

FIG. 1 shows a network arrangement according to various exemplary embodiments.

FIG. 2 shows an exemplary UE according to various exemplary embodiments.

FIG. 3 shows a method for selective AI/ML model training and reporting based on evaluated metrics related to a trustworthiness or quality for the AI/ML model according to various exemplary embodiments.

FIG. 4 shows a method for selective AI/ML model training and reporting based on criteria related to the validity of a training dataset and/or training methods for the AI/ML model according to various exemplary embodiments.

FIG. 5 shows a method for AI/ML model training adaptation based on performance feedback according to various exemplary embodiments.

FIG. 6 shows a method for multi-stage training of a global AI/ML model from multiple partial models according to various exemplary embodiments.

### DETAILED DESCRIPTION

The exemplary embodiments may be further understood with reference to the following description and the related appended drawings, wherein like elements are provided with the same reference numerals. The exemplary embodiments describe operations for ensuring that artificial intelligence (AI) and/or machine learning (ML) models trained by AI agents in a network are trustworthy with regard to quality. The exemplary embodiments provide signaling and reporting mechanisms for providing an AI manager or consumer with information sufficient to determine that an AI/ML model trained remotely by an AI agent can be trusted.

In some aspects, the AI manager (e.g., 5G NR RAN or a network-side function) can indicate to the AI agent (e.g., UE) one or more types of metrics and/or parameters for the AI agent to evaluate regarding the AI model trained (or to be trained) by the AI agent. These metrics can indicate the trustworthiness of the AI model. For example, the AI agent can be instructed to evaluate a confidence level for the AI/ML model (e.g., low, medium or high confidence) or an accuracy metric related to the inferencing error of the AI/ML model. In another example, the AI agent can be provided with certain criteria to evaluate regarding the dataset used to train the AI/ML model, e.g., a size of, age of, or method for collecting the data used to train the model, prior to training and/or reporting the AI model. In other aspects, the AI agent can evaluate these metrics/criteria without an explicit indication from the AI manager.

Still other aspects of these exemplary embodiments relate to performance feedback operations and multi-stage training operations coordinated by the AI manager.

The exemplary aspects are described with regard to a UE. However, the use of a UE is provided for illustrative purposes. The exemplary aspects may be utilized with any electronic component that may establish a connection with a network and is configured with the hardware, software, and/or firmware to exchange information and data with the network. Therefore, the UE as described herein is used to represent any electronic component that is capable of accessing a wireless network and performing AI/ML training or inferencing operations.

The exemplary aspects are described with regard to the network being a 5G New Radio (NR) network and a base station being a next generation Node B (gNB). However, the use of the 5G NR network and the gNB are provided for illustrative purposes. The exemplary aspects may apply to any type of network that utilizes similar functionalities. For example, some AI/ML operations can be RAT-independent.

The exemplary embodiments are further described with regard to artificial intelligence (AI) and/or machine learning (ML) based operations. Any number of different AI/ML models may be used, depending on UE and network implementation. For example, in some embodiments, advanced AI/ML techniques (e.g., a deep learning neural network (NN) ) may be used while in other embodiments simpler AI/ML techniques (e.g., a decision tree) may be used. Further, the various types of models may use different types of data for training the model, including, e.g., radio-related measurements, application-related measurements or sensor data. Thus, reference to any particular AI/ML-based model is provided for illustrative purposes. The exemplary aspects described herein may apply to any type of AI/ML-based modeling that uses a training phase and an inference phase that can be executed at a UE, a RAN (e.g., a network node such as a base station), and/or a network-side function or entity (e.g., a core network element such as a location management function (LMF) for providing UE positioning services; an application server; etc.).

In some embodiments, the AI agent can be a user equipment (UE) in the 5G New Radio (NR) radio access network (RAN) while in other embodiments, the AI agent is a node of the RAN (e.g., a gNB) or a network-side entity, e.g., the core network, RAN or an application server. It should be understood that the techniques described herein may be used regardless of whether the AI agent is a UE, the RAN, or a network-side node and regardless of whether the AI manager is a UE, the RAN, or a network-side node. Those skilled in art will ascertain that the methods by which the UE, RAN or network-side node are enabled with AI agent or AI manager functionalities are varied and can depend on any combination of preconfigured functionalities, RAN configuration/indication, CN entity configuration/indication, UE indication, etc.

Thus, although some techniques are described with respect to a UE being enabled for AI agent functionalities and a RAN (or network-side) node being enabled for AI manager functionalities, any one of the aforementioned entities can serve as the AI manager (e.g., providing one or more types of metrics, assistance information, etc.) or as the AI agent (e.g., training the model, evaluating the metrics, and reporting the trained model). Additionally, in some scenarios, the AI agent and the AI manager can both be network-side nodes or functionalities (e.g., the AI agent is a base station and the AI manager is a core network entity) or can both be UEs (e.g., the AI agent is a first UE and the AI manager is a second UE connected to the first UE via a sidelink).

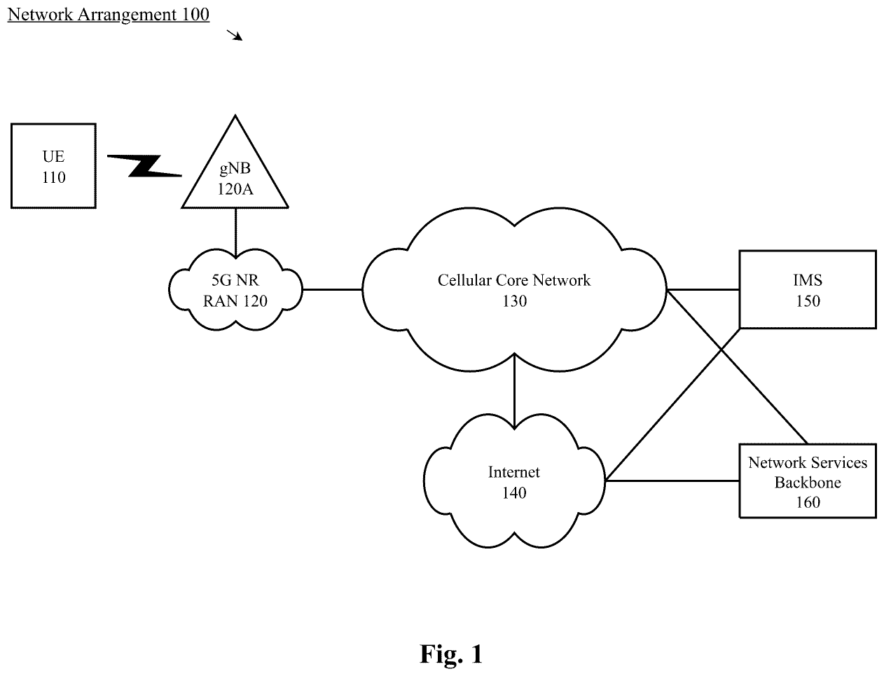

FIG. 1 shows an exemplary network arrangement 100 according to various exemplary embodiments. The exemplary network arrangement 100 includes a user equipment (UE) 110. Those skilled in the art will understand that the UE may be any type of electronic component that is configured to communicate via a network, e.g., mobile phones, tablet computers, smartphones, phablets, embedded devices, wearable devices, Cat-M devices, Cat-M1 devices, MTC devices, eMTC devices, other types of Internet of Things (IoT) devices, etc. It should also be understood that an actual network arrangement may include any number of UEs being used by any number of users. Thus, the example of a single UE 110 is merely provided for illustrative purposes.

The UE 110 may communicate directly with one or more networks. In the example of the network configuration 100, the networks with which the UE 110 may wirelessly communicate are a 5G NR radio access network (5G NR-RAN) 120, an LTE radio access network (LTE-RAN) 122 and a wireless local access network (WLAN) 124. Therefore, the UE 110 may include a 5G NR chipset to communicate with the 5G NR-RAN 120, an LTE chipset to communicate with the LTE-RAN 122 and an ISM chipset to communicate with the WLAN 124. However, the UE 110 may also communicate with other types of networks (e.g., legacy cellular networks) and the UE 110 may also communicate with networks over a wired connection. With regard to the exemplary aspects, the UE 110 may establish a connection with the 5G NR-RAN 122.

The 5G NR-RAN 120 and the LTE-RAN 122 may be portions of cellular networks that may be deployed by cellular providers (e.g., Verizon, AT&T, T-Mobile, etc.). These networks 120, 122 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 124 may include any type of wireless local area network (WiFi, Hot Spot, IEEE 802.11x networks, etc.).

The UE 110 may connect to the 5G NR-RAN via at least one of the next generation nodeB (gNB) 120A and/or the gNB 120B. Reference to two gNBs 120A, 120B is merely for illustrative purposes. The exemplary aspects may apply to any appropriate number of gNBs.

In addition to the networks 120, 122 and 124 the network arrangement 100 also includes a cellular core network 130, the Internet 140, an IP Multimedia Subsystem (IMS) 150, and a network services backbone 160. The cellular core network 130, e.g., the 5GC for the 5G NR network, may be considered to be the interconnected set of components that manages the operation and traffic of the cellular network. The cellular core network 130 also manages the traffic that flows between the cellular network and the Internet 140. The core network 130 may include, e.g., a location management function (LMF) to support location determinations for a UE.

The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

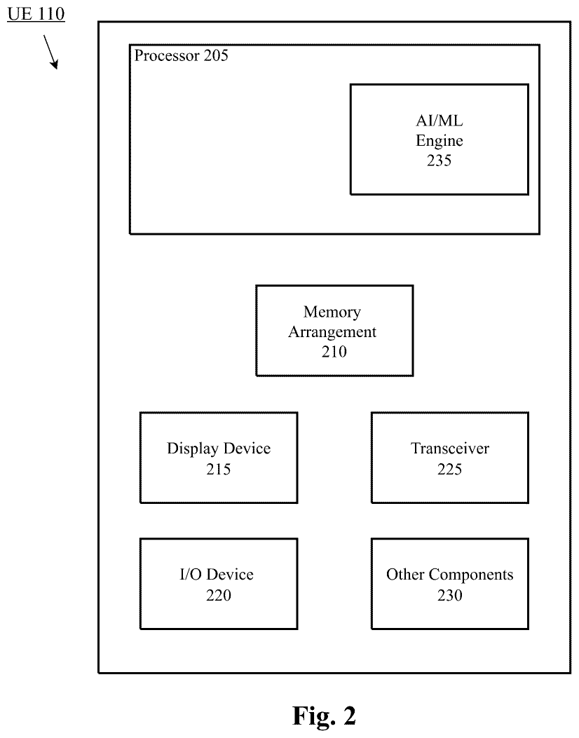

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, Sensors to detect conditions of the UE 110, etc. Additionally, the UE 110 may be configured to access an SNPN.

The processor 205 may be configured to execute a plurality of engines for the UE 110. For example, the engines may include an AI/ML engine 235 for performing various operations related to training an AI/ML model (as an AI agent) or facilitating the training and generation of a trained AI/ML model via one or more remote AI agents (as an AI manager). In some embodiments, when the UE 110 is the AI agent, the AI/ML engine 235 may assess a trustworthiness of an AI/ML model trained (or to be trained) by the UE 110. These operations will be described in greater detail below.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary aspects may be implemented in any of these or other configurations of a UE.

The memory 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G-NR RAN 120, the LTE RAN 122 etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

The exemplary network base station, in this case gNB 120A, may represent a serving cell for the UE 110. The gNB 120A may represent any access node of the 5G NR network through which the UE 110 may establish a connection and manage network operations. The gNB 120A may include a processor, a memory arrangement, an input/output (I/O) device, a transceiver, and other components. The other components may include, for example, an audio input device, an audio output device, a battery, a data acquisition device, ports to electrically connect the gNB 120A to other electronic devices, etc. The functionality associated with the processor of the gNB 120A may also be represented as a separate incorporated component of the gNB 120A or may be a modular component coupled to the gNB 120A, e.g., an integrated circuit with or without firmware. For example, the integrated circuit may include input circuitry to receive signals and processing circuitry to process the signals and other information. In addition, in some gNBs, the functionality described for the processor is split among a plurality of processors (e.g., a baseband processor, an applications processor, etc.). The exemplary aspects may be implemented in any of these or other configurations of a gNB.

The memory may be a hardware component configured to store data related to operations performed by the UEs 110, 112. The I/O device may be a hardware component or ports that enable a user to interact with the gNB 120A. The transceiver may be a hardware component configured to exchange data with the UE 110 and any other UE in the system 100. The transceiver may operate on a variety of different frequencies or channels (e.g., set of consecutive frequencies). Therefore, the transceiver may include one or more components (e.g., radios) to enable the data exchange with the various networks and UEs. The transceiver includes circuitry configured to transmit and/or receive signals (e.g., control signals, data signals). Such signals may be encoded with information implementing any one of the methods described herein. The processor may be operably coupled to the transceiver and configured to receive from and/or transmit signals to the transceiver. The processor may be configured to encode and/or decode signals (e.g., signaling from a UE) for implementing any one of the methods described herein.

Artificial Intelligence (ai) and Machine Learning (ml) is envisioned to be an integral part of Beyond 5G (B5G) (Rel-18 and beyond), as well as 6G. In particular, AI/ML may play a role for the optimization of network functionalities. AI/ML models trained by the AI agent(s) in the network may be used to facilitate certain decision makings in one or more network functionalities (e.g., in RAN or Core Network), including but not limited to: beam management; positioning, resource allocation; network management (operation and management (OAM)); route election; energy saving; and load Balancing. In addition, in AI-as-a-Service (AIaaS), the AI/ML services can be consumed by applications initiated at either the user or network side. The trained AI/ML model can be provided by any AI agent reachable in the network, including the UE. In various use cases, one or more UEs in a network may function as AI agents who can train at least a part of AI/ML models based on, e.g., data collected locally by each UE (e.g., radio-related or application-related measurements, sensor input, etc.).

When the AI/ML model is trained by the UE for provision by the network as services to be consumed by some functions externally instantiated (e.g., on the network side or in an application server), the UE needs to report/transfer the trained models to the network. Similarly, when Federated Learning (FL) is used, the UE reports/transfers the trained models to the network for model fusion.

FL operation for the 5G system is specified in 3GPP TS 22.261. In FL, a cloud server hosting a model aggregator trains a global model by aggregating local models partially trained by multiple end devices, e.g., UEs. Within each training iteration, a UE downloads an untrained model from the AI server and performs the training based on local training data. The UE reports the interim training results to the cloud server via 5G UL channels and the server aggregates the interim training results from the UEs and updates the global model. The updated global model is then distributed back to the UEs and the UEs can perform the training for the next iteration.

In many scenarios, it is crucial to ensure that the trained AI/ML models meet a minimum required quality and can be trusted by the clients (e.g., network functions, UEs and/or external applications) using the AI/ML services. Particularly in FL use cases, if the training results from one AI agent do not meet the required quality, the aggregated global model may become misleading. For critical applications (e.g., autonomous driving), a poor quality AI/ML model can have disastrous effects.

The quality of a trained AI model can be assessed in a variety of manners. For example, key metrics of model quality relate to accuracy, robustness, stability and data quality. The accuracy of a trained AI model can be assessed by performing an error analysis using test examples to compare expected (known) results with the inferencing results generated by the trained AI model. If the inferencing error (or probability of inferencing error) is sufficiently high, the parameters of the model may be adjusted or the model may be retrained to achieve a higher degree of accuracy. In other examples, the robustness of the model can be assessed by subjecting the model to large variances in input data, e.g., to simulate poor input data, and the stability of the model can be assessed by determining the consistency in the results when only small variances are applied in the input data. The data quality relates to attributes such as the size, age and source of the training data set.

The quality or trustworthy level of an AI/ML model may be influenced by the following factors (not an exhaustive list): the size of the dataset used for model training; the age of the dataset used for model training; the collection method of the dataset used for model training; the correctness of the dataset used for model training; the “integrity” of the dataset collection; the algorithm used for model training; and other factors. Thus, in the context of this description it may be considered that trustworthy or trustworthiness may also be synonymous with “valid,” “adequate” or “integrity.”

It is crucial to ensure the AI/ML models trained at an AI agent can meet a minimum required quality, and therefore can be trusted by the clients (including, e.g., UEs, RAN nodes, network functions and/or external applications) using AI/ML services.

According to various exemplary embodiments described herein, operations are described for ensuring AI/ML models trained by AI agents are trustworthy with respect to quality, and therefore can be applied for inferencing by other network functions and/or third-party applications. It should be understood that the exemplary embodiments may be described with respect to the AI agent (the entity training/reporting the AI/ML model) being a UE. However, certain aspects of the present disclosure may be applicable to other entities serving as the AI agent, e.g., a RAN node or network-side node, as described further below. Additionally, in some scenarios, the AI agent and the AI manager can both be network-side nodes or functionalities (e.g., the AI agent is a base station and the AI manager is a core network entity) or can both be UEs (e.g., the AI agent is a first UE and the AI manager is a second UE connected to the first UE via a sidelink). Thus, the AI agent (or AI agent node) can refer to any type of UE or network node and the AI manager (or AI manager node) can refer to any type of UE or network node.

The exemplary embodiments provide signaling and reporting mechanisms for providing an AI manager or consumer with information sufficient to determine that an AI/ML model trained remotely by an AI agent can be trusted. In some aspects, the AI manager (e.g., 5G NR RAN or a network function) can indicate to the AI agent (e.g., UE) one or more types of metrics for the AI agent to evaluate regarding the AI model trained (or to be trained) by the AI agent. For example, the AI agent can be instructed to evaluate a confidence level for the AI/ML model or a metric related to the inferencing error of the AI/ML model. In another example, the AI agent can be provided with certain criteria to evaluate, e.g., a size of, age of, or method of data collection, prior to training and/or reporting the AI model. In other aspects, the AI agent can evaluate these metrics/criteria without an explicit indication from the AI manager. Still other aspects of these exemplary embodiments relate to performance feedback operations and multi-stage training operations coordinated by the AI manager.

According to One Aspect of These Exemplary embodiments, one or more metrics relating to the trustworthiness of the AI/ML model may be determined by the AI agent (e.g., the UE) and reported or provided to the AI manager/consumer in association with the trained AI/ML model. Based on the reported metrics, the AI manager (e.g., the 5G NR RAN) can determine whether the trained model has a sufficient quality or trustworthiness to be used for inferencing. In some embodiments, the metrics can relate to the accuracy of the trained AI/ML model and include, e.g., the probability that the inferencing error of the AI/ML model exceeds a threshold; the probability distribution parameter(s) of the inferencing error of the AI/ML model (e.g., the mean and standard deviation, the type of distribution, etc.); or the maximum possible value of the inferencing error of this AI/ML model.

In other embodiments, the metric can be an integer value that marks the overall confidence level of this AI/ML model. For example, the confidence level can be selected from among values indicating low confidence, medium confidence or high confidence (e.g., 0=Low, 1=Medium, 2=High). Those skilled in the art will ascertain that additional values can also be used, or the indication can be a binary flag, e.g., trustable or not trustable.

The method by which the AI agent (e.g., UE) evaluates these metrics for trustworthiness may be based on the particular implementation of the node (e.g., the evaluation algorithm is not mandated by specifications). To ensure that the AI manager entity can trust that the AI agent entity will use trustworthiness evaluation methods that are acceptable to the AI manager, security certificate(s) may be exchanged between the AI agent and the AI manager prior to evaluating the metric and/or training the AI/ML model.

The AI manager may indicate the type of trustworthy level metric to be evaluated before the AI agent initiates its training functionalities so that the AI agent knows what metric should be evaluated and reported. In some embodiments, the AI agent may report the trustworthy level metrics only when the evaluated metrics meet (or fail to meet) certain conditions, e.g., when the trustworthy level is lower than a threshold. In one example, when the AI/ML model is evaluated by the AI agent to be trustworthy, the AI agent can skip the reporting of such metric(s). In this example, if the model is evaluated to be not trustworthy, the AI agent can provide the metric(s) to the AI manager so that the AI manager can, e.g., suggest ways to improve the training of the AI model. In another example, when the AI/ML model is evaluated by the AI agent to be trustworthy, the AI agent can report the trustworthy level/metric. This information can be used by the AI manager to, e.g., select a group of models with very high trustworthy levels as a first group of partial models to fuse into an aggregated global model (e.g., in federated learning (FL) operations). In still another example, the AI/ML model and the associated metrics can be reported automatically and regardless of the values of the evaluated metrics.

The AI manager may provide some assistance information, e.g., parameters relating to acceptable or unacceptable trustworthiness metrics, for the AI agent to evaluate the trustworthy level metrics. For example, the AI agent may be provided with a targeted inferencing error, e.g., the maximum inferencing error that can be tolerated. In another example, the AI agent may be provided with a threshold of inferencing error, e.g., when the trustworthy level metric is to be characterized by the probability where the inferencing error of the AI/ML model exceeds a threshold.

In still another example, the assistance information can comprise parameters relating to the dataset collection by the AI agent. For example, in positioning methods where the AI manager is the 5G NR RAN (or the LMF in the core network) and the AI agent is the UE, the AI manager may first provide satellite health conditions if the one or more entries in the dataset corresponds to GNSS positioning. The UE can consider this assistance information when assessing the trustworthy metric, e.g., an integer value associated with a confidence level for the model quality (e.g., low, medium or high confidence).

In another aspect, the AI agent can evaluate the one or more metrics and based on the evaluation, determine whether the AI/ML model should be trained and/or reported. In these aspects, the AI agent may be provided with an indication of the type of metric to be evaluated and determine whether a threshold of trustworthiness is satisfied based on the implementation of the AI agent (e.g., UE implementation), similar to above. For example, the metric may be a confidence measure, e.g., a low, medium or high level of trustworthiness, or a probability (or probability distribution parameter) for an inferencing error of the AI/ML model.

If the targeted AI/ML model is not yet trained, the AI agent can evaluate whether it is able to obtain a model that can satisfy the one or more pre-configured trustworthy level threshold/metric based on, e.g., the characteristics of its training dataset. If the AI agent determines it can satisfy the metric, the UE may proceed to train the AI/ML model. If the AI agent is configured to train multiple models, the AI agent may determine which model should be trained based on which preconfigured threshold/condition is satisfied. If the AI agent determines it cannot satisfy the metric, the AI agent may choose not to train a model, and/or it can wait until a qualified dataset is collected, and then train the model accordingly.

Alternatively, even when the trustworthy metric is not satisfied for a model yet to be trained, the UE may still train/report the model and indicate the “achievable” trustworthy level of the trained model based on the evaluation prior to training.

If the targeted AI/ML model is already trained, the UE can evaluate whether the trained model can satisfy the pre-configured trustworthy level threshold (based on, e.g., the characteristics of the dataset that has been used to train the model). If the UE determines it can satisfy the metric, the UE may proceed to report the trained model. If the UE determines it cannot satisfy the metric, the UE may choose to skip reporting.

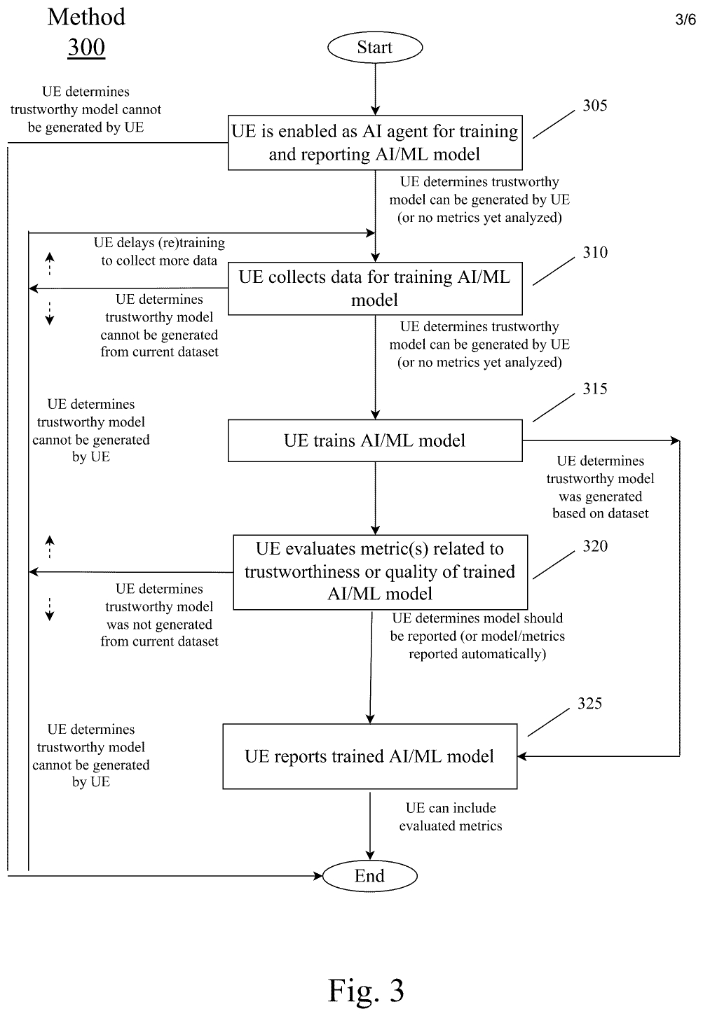

FIG. 3 shows a method 300 for selective AI/ML model training and reporting based on evaluated metrics related to a trustworthiness or quality for the AI/ML model according to various exemplary embodiments. In this example, the AI manager comprises the 5G NR RAN or a network-side functionality instantiated externally to the RAN (e.g., a core network entity or application server) and the AI agent comprises a UE.

In 305, the UE is enabled as an AI agent for training and reporting an AI/ML model. It should be understood that certain aspects of the AI agent functionalities can be preconfigured, while other aspects of the AI agent functionalities can be indicated to or configured for the UE by the network. In one example, the UE can be hard-encoded with features that enable the training of one or more types of AI/ML models. In another example, the UE can download an untrained AI/ML model from the RAN. In still another example, the UE can first exchange capability-related information (and/or a security certificate) with the RAN prior to receiving a configuration from the network that activates one or more AI/ML training techniques.

Depending on the type of AI/ML model to be trained, the UE may receive additional configurations from the network. For example, if the AI/ML model relates to channel estimation, the UE may be configured with a training set of reference signals (RS) to measure and use to train the model. In another example, if the AI/ML model relates to positioning, the UE may be configured with a traditional positioning method (e.g., GNSS or OTDOA) to use to gather positioning data for training the model. Those skilled in the art will understand the types of AI/ML models that can be received and trained by the UE are varied and the AI agent functionalities can be enabled for the UE in any number of different ways depending on the nature of the AI/ML model.

In some embodiments, the UE receives some additional information from the network prior to collecting data for training the AI/ML model. For example, the UE may receive an indication of one or more types of metrics related to trustworthiness. As described above, the metric can be related to an accuracy of the AI/ML model (e.g., a maximum inferencing error), a confidence value (e.g., high confidence or low confidence), etc., to be described in further detail below in step 320. In another example, the UE may receive some assistance information from the network relating to the dataset collection that may inform the UE determination/evaluation of the trustworthiness metric.

In some embodiments, when the UE receives this additional information from the network prior to collecting the data, the UE may determine from this information that it cannot generate a trustworthy model to report to the network. If this occurs, the UE can determine not to collect data or train the model and the method ends. If the UE determines that it can generate a trustworthy model to report to the network, or if this type of evaluation is not performed, the method proceeds to 310.

In 310, the UE collects data for training the AI/ML model. As described above, the manner by which the UE collects the training data depends on the type of AI/ML model being trained. In one example, if the AI/ML model relates to channel estimation, the UE may measure a training set of RS to process and use as model input. In another example, if the AI/ML model relates to positioning, the UE may be performing a traditional positioning method (e.g., GNSS) to gather positioning data to process and use as model input. In still another example, the UE may receive data from an external sensor. Those skilled in the art will understand the types of data collected for training the AI/ML models are varied and can be collected in any number of different ways depending on the nature of the AI/ML model.

In some embodiments, similar to 305, the UE receives some additional information from the network prior to training the AI/ML model with the collected data, including, e.g., the indication of one or more types of metrics related to trustworthiness, or assistance information.

The UE can, based on this additional information and the currently collected dataset, determine that it cannot generate a trustworthy model to report to the network. If this occurs, the UE can determine not to train the model and the method ends. Alternatively, the UE can wait until a qualified dataset is collected prior to training the model. If the UE determines that it can generate a trustworthy model to report to the network based on a currently collected dataset, or if this type of evaluation is not performed, the method proceeds to 315.

In 315, the UE trains the AI/ML model and generates a trained AI/ML model. In some embodiments, if the AI/ML model was trained with a dataset that was previously determined to be a sufficient dataset (e.g., based on additional information received from the network regarding acceptable parameters for the dataset), the method proceeds to 325 and the UE reports the trained AI/ML model without any further evaluation of the trained AI/ML model. If this type of evaluation is not performed, after training, the method proceeds to 320.

In 320, the UE evaluates one or more metrics related to the trustworthiness or quality of the trained AI/ML model. As described above, the metric can be related to an accuracy of the AI/ML model (e.g., a maximum inferencing error), a confidence value (e.g., high confidence or low confidence), or qualities of the dataset used to train the model.

The UE can make various determinations based on the evaluated metrics. In one example, the UE can determine the trustworthy level of the trained AI/ML model meets or fails to meet a minimum threshold. In another example, the UE can determine, based on the trained model meeting or failing to meet the minimum threshold, that the model should or should not be reported. In another example, the UE can determine that the AI/ML model does not meet the required quality metric but should still be reported (in association with the quality metric). In still another example, no determinations are made by the UE based on the evaluated metrics, and both the trained AI/ML model and the associated metrics are reported automatically.

If the UE determines not to report the model, the method can end. Alternatively, the UE can collect additional data and retrain the AI/ML model in an attempt to improve the quality to a level sufficient for reporting. If the UE determines to report the model, the method proceeds to 325.

In 325, the UE reports the trained AI/ML model to the network. In some embodiments, the UE can include the trustworthy metric when reporting the trained AI/ML. In other embodiments, e.g., when the AI/ML model is determined to be trustworthy, the UE skips the reporting of such metrics.

It should be understood that similar techniques may be used regardless of whether the AI agent is a UE, the RAN, or a network-side node such as a core network function or an application server and regardless of whether the AI manager is a UE, the RAN, or a network-side node. Those skilled in art will ascertain that the methods by which the UE, RAN or network-side node are enabled with AI agent or AI manager functionalities are varied and can depend on any combination of preconfigured functionalities, RAN configuration/indication, CN entity configuration/indication, UE indication, etc. Thus, although the method 300 of FIG. 3 is described with respect to a UE being enabled for AI agent functionalities and a RAN (or network-side) node being enabled for AI manager functionalities, any one of the aforementioned entities can serve as the AI manager (e.g., providing one or more types of metrics, assistance information, etc.) or as the AI agent (e.g., evaluating the metrics and reporting the trained model) in various types of AI/ML operations/applications.

In another aspect of these exemplary embodiments, the AI agent can be provided with criteria for a valid dataset that is considered suitable for training a trustworthy AI/ML model. For example, the criteria can relate to the size or age of the dataset used for training. In another example, the criteria can relate to a method used for collecting the training data, a source of the training data, or the type of algorithm used for AI/ML model training. If the criteria are not met, the AI agent may refrain from training the AI/ML model. In still another aspect, the AI agent can report these criteria for a trained model and the AI manager or consumer can determine, based on the reported criteria, whether the trained model is trustworthy. In a related aspect, the AI agent can report these criteria prior to training the model and based on the evaluation by the AI manager/consumer, the AI manager/consumer can provide a response (positive or negative) to the AI agent regarding whether to train the AI/ML model.

In these aspects, the criteria relate to parameters or qualities of the dataset used to train the model and/or the method for training the model. The AI manager first provides to the AI agent information regarding the criteria for a valid dataset.

In some embodiments, the criteria may include the minimum size or the maximum age of the dataset used for training the model. A small dataset (below the minimum size indicated by the AI manager) or an old dataset (above the maximum age indicated by the AI manager) may be considered by the AI manager as not trustable, while a larger dataset (above the minimum size) or a newer dataset (below the maximum age) may be considered trustable.

In another embodiment, the criteria may include the method(s) used for dataset collection. Multiple types of methods for data collection may be enabled (or potentially enabled) for the UE, but only some of these methods may be acceptable to the network. For example, if the AI/ML model is for UE positioning, only the UE positions estimated by certain methods (e.g., GNSS) can be considered as trustable. In still another embodiment, the criteria may include the algorithm used for AI/ML model training. The dataset may be considered trustable only if certain algorithms (e.g., deep learning) were used while other algorithms (e.g., decision tree) may be considered not trustable

In still another embodiment, the criteria may include the source of the dataset. For some AI/ML models, the AI agent, e.g., the UE, may gather data from sources external to the UE. For example, in industrial settings, the AI agent may be a robot that is coupled to various types of sensors that may not be authenticated by the network. In these scenarios, where the source of the dataset is from a not trustworthy device, the AI/ML models trained by such a dataset cannot be considered as trustable.

Based on the criteria received from the AI manager, the AI agent may have the following behavior. The AI agent can first check if it is able to train an AI/ML model based on the criteria (e.g., it has a qualified dataset). If the AI agent determines the dataset is valid, the AI agent may proceed to train the AI/ML model. If the AI agent determines the dataset is not valid, the AI agent may refrain from training the AI/ML model. The AI agent may proceed to accumulate additional data in an attempt to satisfy the criteria and, if the criteria are eventually satisfied, the AI agent can train the model. Optionally, the AI agent may directly notify the AI manager that it is unable to perform this AI/ML model training tasks.

In a related aspect, the AI agent can provide the AI manager with some context information relating to the dataset acquired by the AI agent, prior to training the model. Based on the context information received from the AI agent, the AI manger can determine if the UE can obtain a trustable AI/ML. This context information may be similar to the criteria discussed above, e.g., the size of the dataset to be used to train the model; the age of the dataset to be used to train the model; the methods used for collection of the dataset to be used to train the model; the algorithm to be used for training the model; and the source of the dataset. Additionally, the context information can include a trustworthy level metric determined from at least one preceding AI/ML model.

Based on the context information received from the AI agent, the AI manager may determine if the AI agent can obtain an AI/ML model that is considered trustable. If the AI manager determines that the context is trustable, the AI manager may provide a positive response to the AI agent, instructing the AI agent to train the AI/ML model based on the context. If the AI manager determines the context is not trustable, the AI manager may provide a negative response to the AI agent, and the AI agent may refrain from training the AI/ML model. In one option, the AI manager may further provide information for how the context/dataset can be improved to provide a trustworthy context. For example, the AI manager can indicate to the AI agent that the size of the dataset should be increased.

In still another related aspect, the AI agent may already possess a previously trained AI/ML model that it has not yet reported to the AI manager. In these aspects, the AI agent can provide the AI manager some context information relating to how this AI/ML model has been trained. This context information may be similar to the context information discussed above, e.g., the size of the dataset used to train the model; the age of the dataset used to train the model; the methods used for collection of the dataset used to train the model; the algorithm used for training the model; and the source of the dataset. Additionally, the context information can include a trustworthy level metric determined from at least one preceding AI/ML model.

Based on the information received from the AI agent, the AI manager may determine if the AI/ML model trained based on such context could be considered trustable. If the AI manager determines that the context is trustable, the AI manager may provide a positive response to the AI agent, instructing the AI agent to report the trained AI/ML model. If the AI manager determines the context is not trustable, the AI manager may provide a negative response to the AI agent, and the AI agent may refrain from reporting the trained AI/ML model. In one option, the AI agent may discard the trained AI/ML model. In another option, the AI agent may store the trained AI/ML model for a certain period of time, as it could be used for future training/updating.

In one embodiment, the AI manager may also instruct the AI agent regarding what to do with the trained AI/ML model. For example, the AI manager can include such instructions in the response message including the negative response for reporting the model. In another embodiment, the AI agent can determine what to do with the trained AI/ML model based on how many times the context checking has failed. For example, if the context checking is failed only one time, the AI agent may store the model for future use. If the context checking fails multiple times, the AI agent may discard the model.

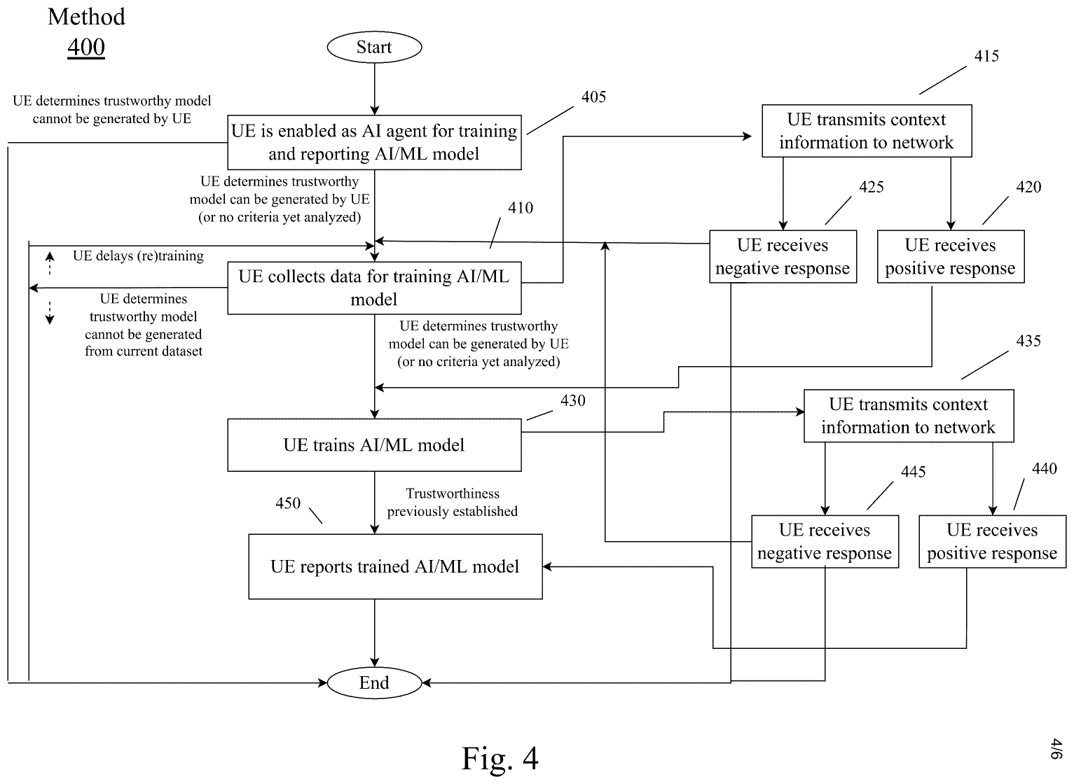

FIG. 4 shows a method 400 for selective AI/ML model training and reporting based on criteria related to the validity of a training dataset and/or training methods for the AI/ML model according to various exemplary embodiments. In this example, similar to the method 300 of FIG. 3, the AI manager comprises the 5G NR RAN or a network-side functionality instantiated externally to the RAN (e.g., a core network entity or application server) and the AI agent comprises a UE.

In 405, the UE is enabled as an AI agent for training and reporting an AI/ML model. Similar to 305, the AI agent functionalities can be enabled for the UE in a variety of ways. Depending on the type of AI/ML model to be trained, the UE may receive additional configurations/indications from the network.

In some embodiments, the UE receives some additional information from the network prior to collecting data for training the AI/ML model. For example, the UE may receive information on criteria for a valid dataset, including a type of context information for the dataset and/or thresholds to be met regarding the context information for the dataset. As described above, the criteria can be related to a minimum size or maximum age of the dataset, the method to be used for dataset collection, the algorithm to be used for training the AI/ML model, or the source of the data to be gathered (e.g., whether the data is from an untrusted device remote to the UE).

In some embodiments, when the UE receives these criteria from the network prior to collecting the data, the UE may determine from this information that it cannot generate a trustworthy model to report to the network. For example, the UE may be unable to meet one or more of the criteria based on UE capabilities. If this occurs, the UE can determine not to collect data or train the model and the method ends. If the UE determines that it can generate a trustworthy model to report to the network, or if this type of evaluation is not performed, the method proceeds to 410.

In 410, the UE collects data for training the AI/ML model. As described above, and similar to step 310 of FIG. 3, the manner by which the UE collects the training data depends on the type of AI/ML model being trained. Those skilled in the art will understand the types of data collected for training the AI/ML models are varied and can be collected in any number of different ways depending on the nature of the AI/ML model.

In some embodiments, similar to 405, the UE receives some additional information from the network prior to training the AI/ML model with the collected data, including, e.g., the criteria described above. The UE can determine context information for its dataset including, e.g., the size or age of the dataset, etc. In other embodiments, the UE determines the context information for the dataset, including, e.g., its size, its age, etc., based on UE implementation (e.g., without a network instruction or additional information). In some embodiments, prior to training the model, the UE can report this context information to the network.

In 415, the UE transmits its context information for the dataset to the network. If the network determines the UE can obtain a trustable model from the context information, the network can transmit a positive response to the UE instructing the UE to train the model based on the reported context. In 420, the UE receives the positive network response and the method proceeds to 430. If the network determines the UE cannot obtain a trustable model from the context information, the network can transmit a negative response to the UE instructing the UE not to train the model based on the reported context. In 425, the UE receives the negative network response. In some embodiments, the method can end after the negative network response is received. In other embodiments, the UE may attempt to improve the dataset and the method can return to 410, where the UE collects additional data. In some embodiments, in the negative response, the network can further provide information for improving the context, e.g., instructions to increase the size of the dataset.

Returning to 410, if the UE has not yet determined any context information and/or the context information satisfies previously received criteria, the UE can determine to train the AI/ML model and the method proceeds to 430.

In 430, the UE trains the AI/ML model and generates a trained AI/ML model. In some embodiments, if the AI/ML model was trained with a dataset that was previously determined to be a sufficient dataset (e.g., based on the criteria/context information received from the network regarding acceptable parameters for the dataset), the method proceeds to 450 and the UE reports the trained AI/ML model without any further evaluation of the trained AI/ML model. In other embodiments, the UE determines the context information for the dataset, including, e.g., its size, its age, etc., based on either network instruction or UE implementation (e.g., without a network instruction or additional information). In some embodiments, prior to reporting the model, the UE can report this context information for the trained model to the network.

In 435, the UE transmits its context information for the trained model to the network. If the network determines the UE can obtain a trustable model from the context information, the network can transmit a positive response to the UE instructing the UE to report the model based on the reported context. In 440, the UE receives the positive network response and the method proceeds to 450. If the network determines the UE cannot obtain a trustable model from the context information, the network can transmit a negative response to the UE instructing the UE not to report the model based on the reported context. In 445, the UE receives the negative network response. In some embodiments, the method can end after the negative network response is received. In other embodiments, the UE may attempt to improve the dataset and the method can return to 410, where the UE collects additional data. In some embodiments, in the negative response, the network can further provide information for improving the context, e.g., instructions to increase the size of the dataset.

Returning to 430, if the trustworthiness of the AI/ML model was previously established from the characteristics of the dataset, the UE can report the trained AI/ML model. In 450, the UE reports the trained AI/ML model to the network.

Similar to the method 300 of FIG. 3, it should be understood that similar techniques may be used regardless of whether the AI agent is a UE, the RAN, or a network-side node such as a core network function or an application server and regardless of whether the AI manager is a UE, the RAN, or a network-side node. Those skilled in art will ascertain that the methods by which the UE, RAN or network-side node are enabled with AI agent or AI manager functionalities are varied and can depend on any combination of preconfigured functionalities, RAN configuration/indication, CN entity configuration/indication, UE indication, etc. Thus, although the method 400 of FIG. 4 is described with respect to a UE being enabled for AI agent functionalities and a RAN (or network-side) node being enabled for AI manager functionalities, any one of the aforementioned entities can serve as the AI manager (e.g., providing one or more types of metrics/criteria, evaluating the criteria, etc.) or as the AI agent (e.g., reporting the context information, evaluating the criteria, etc.) in various types of AI/ML operations/applications.

In still another aspect of these exemplary embodiments, the AI manager can evaluate the performance of an AI/ML model reported by the AI agent. The AI manager can evaluate the model in various ways, e.g., for accuracy, robustness, stability, etc., as described above. In these embodiments, it is assumed that the trained AI/ML model previously reported by the AI agent was considered trustworthy by the AI manager (or such a trustworthy level check was not performed).

After a period of time during which one or more models trained by the AI agent has been reported and used by the AI manager, the AI manager evaluates the performance of AI/ML models reported by the UE. The performance may be characterized by, e.g., an accuracy level of the reported model(s); a percentage of correct inference based on the reported models; or a performance index of the functionalities that have used the reported models. For example, if the AI/ML model relates to air interface operations, the block error rate (BLER) of transmission/reception based on the air interface operations controlled using the reported model can be evaluated.

The AI manager may provide feedback about the AI/ML model performance to the AI agent. In one embodiment, the AI manager may directly provide the performance result. In another embodiment, the AI manager may directly indicate whether the AI agent should improve the context of AI/ML model, e.g., if the AI agent should further expand its dataset for AI/ML model training. In still other embodiment, the AI manager may instruct the AI agent to pause AI/ML model training until the AI agent has an improved context for AI/ML model training, and/or may instruct the AI agent to quit from AI/ML model training tasks.

Based on the feedback, the AI agent may determine whether/how it should adapt and improve the trustworthy level of the AI/ML model it can train.

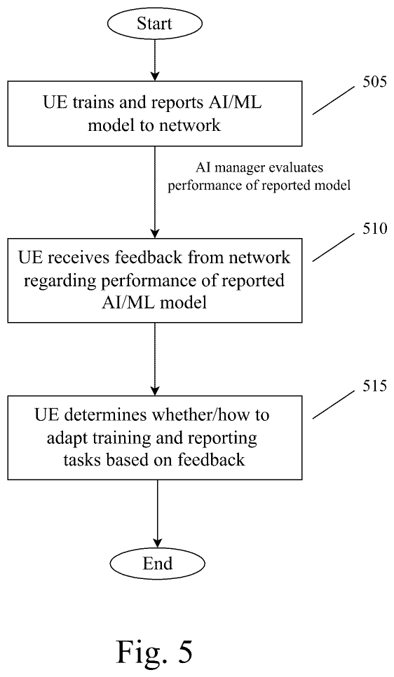

FIG. 5 shows a method 500 for AI/ML model training adaptation based on performance feedback according to various exemplary embodiments. In this example, similar to the methods 300 and 400 of FIGS. 3-4, the AI manager comprises the 5G NR RAN or a network-side functionality instantiated externally to the RAN (e.g., a core network entity or application server) and the AI agent comprises a UE.

In 505, the UE trains and reports an AI/ML model to the network. Similar to above, the AI agent functionalities can be enabled for the UE in a variety of ways. Depending on the type of AI/ML model to be trained, the UE may receive additional configurations/indications from the network prior to training and reporting the model.

In this example, it is assumed that the AI/ML model reported by the UE is considered trustworthy. That is, the method 300 and/or the method 400 described above can be performed, in whole or in part, prior to reporting the AI/ML model of the method 500. Alternatively, the method 500 can be performed without any previous analysis of the trustworthiness of the model (e.g., trustworthiness can be established in a different manner or not established).

After some duration of time during which the AI/ML model is used by the network (or the network-side entity), the network can evaluate the performance of the reported model. The performance can be characterized by accuracy, e.g., an accuracy level or a percentage of correct inference, or by a performance index for network functionalities that use the model, e.g., an air interface performance.

In addition, in some embodiments, the network can evaluate further actions that the UE should take. For example, the network can determine how the UE can improve the AI/ML model (e.g., by expanding the dataset used to train the model) or whether the UE should pause or quit training the model.

In 510, the UE receives feedback from the network regarding the performance of the AI/ML model reported by the UE. In some embodiments, the UE may receive only a performance result. In other embodiments, the UE may receive further information for improving the model. In still other embodiments, the UE may receive instructions from the network regarding further actions to take regarding the AI/ML model, e.g., to retrain the model, to pause the training, or to quit from the AI/ML model training tasks. It should be understood that multiple types of information may be provided in the feedback

In 515, based on the feedback, the UE determines whether and how to adapt its training tasks. In some embodiments, the UE may follow the network instructions (e.g., to retrain the model or to pause/quit the training). In other embodiments, the UE may perform its own evaluation regarding how to improve the model. For example, based on the performance result, the UE can determine that the AI/ML model should be retrained with a new dataset or that the current dataset should be improved.

If the UE determines (or is instructed) to retrain the model, the UE can perform the new training task and report the new model to the network. Further feedback can be provided to the UE in a similar manner as described above.

Similar to the method 300 of FIG. 3 and the method 400 of FIG. 4, it should be understood that similar techniques may be used regardless of whether the AI agent is a UE, the RAN, or a network-side node such as a core network function or an application server and regardless of whether the AI manager is a UE, the RAN, or a network-side node. Those skilled in art will ascertain that the methods by which the UE, RAN or network-side node are enabled with AI agent or AI manager functionalities are varied and can depend on any combination of preconfigured functionalities, RAN configuration/indication, CN entity configuration/indication, UE indication, etc. Thus, although the method 500 of FIG. 5 is described with respect to a UE being enabled for AI agent functionalities and a RAN (or network-side) node being enabled for AI manager functionalities, any one of the aforementioned entities can serve as the AI manager (e.g., evaluating the trained model, providing feedback, etc.) or as the AI agent (e.g., receiving the feedback, improving the model, etc.) in various types of AI/ML operations/applications.

In still another aspect of these exemplary embodiments, the AI manager can control the training of an aggregate model in multiple stages. In this aspect, the AI manager is an entity hosting a model aggregator, e.g., for federated learning (FL) operations. As described above, the AI manager in FL operations can be a network-side entity, e.g., a core network function or an application server, instructing multiple AI agents, e.g., UEs, to train and report respective partial models for fusion into a global model (e.g., an additional training stage from multiple partial trained models). However, these aspects are not limited to FL operations and any type of AI/ML model and/or AI manager/agent entities can be used.

In these aspects, it is assumed that the AI manager already has some knowledge about the context of certain AI agents and knows which AI agents are able to provide more trustworthy AI/ML models. The AI manager can first select a (relatively small) group of “trustworthy” AI agents and instruct these AI agents to train (partial) AI/ML models. Once the models are collected from this group of trustworthy AI agents, the AI manager aggregates these partial models to produce a first version of the global model.

The AI manager may verify/evaluate the first version of the global model to ensure that it is actually trustworthy. If the model is evaluated to be not trustworthy, the AI manager may discard it, and select another group of AI agents to generate partial models for aggregation into another global model.

If the model is verified to be trustworthy, the AI manager may determine that global model has a strong, quality core, and proceed to instruct further AI agents (e.g., a larger set of AI agents) to be involved in the model refinement to generate a second version of the global model. Even if some of the further AI agents are “less trustworthy” than the initial Set of AI agents, the strength of the first version of the global model will prevent additional (poor quality) models from substantially affecting the performance of the second version of the global model.

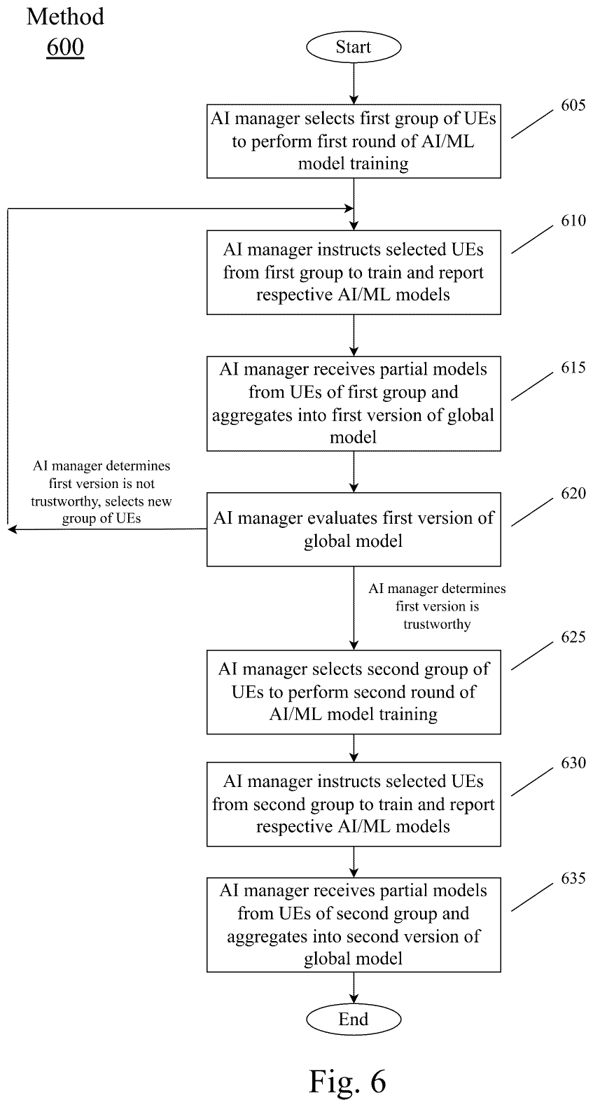

FIG. 6 shows a method 600 for multi-stage training of a global AI/ML model from multiple partial models according to various exemplary embodiments. In this example, the AI manager comprises the 5G NR RAN or a network-side functionality instantiated externally to the RAN (e.g., a core network entity or application server) and the AI agents comprise UEs.

In this example, it is assumed that the AI manager has some knowledge of the AI/ML training capabilities, or previously performed training operations (e.g., context information), of certain UEs enabled as AI agents.

In 605, the AI manager selects a first group of UEs to perform a first round of AI/ML model training. Each UE from this first group can be determined by the AI manager to be trustworthy. This can be determined in various ways, e.g., based on the performance of previously reported AI/ML models, based on context information received from the UE (e.g., in accordance with the method 400 of FIG. 5), or in other ways.

The first group of UEs may be relatively small compared to the total number of UEs to be used to train the model (in later step 7XX).

In 610, the AI manager instructs each of the selected UEs from the first group to train and report respective AI/ML models.

In 615, the AI manager receives partial AI/ML models from the UEs of the first group and aggregates these partial models into a first version of a global model.

In 620, the AI manager evaluates the first version of the global model to determine whether the first version is trustworthy. For example, the AI manager can evaluate the accuracy, robustness, stability, etc., of the first version of the global model. If the first version of the global model is evaluated to be not trustworthy, the AI manager can discard the first version of the model and select a new group UEs as the “first group” of UEs (e.g., a new group of “trustworthy” UEs). In this scenario, the method can return to 610 and the AI manager can instruct this new group of UEs to train and report partial models.

If the first version of the global model is evaluated to be trustworthy, the AI manager can determine to refine the model and the method proceeds to 625.

In 625, the AI manager selects a second group of UEs to perform a second round of AI/ML model training. In some embodiments, e.g., in FL operations, the second group of UEs may be significantly larger than the first group selected in 610. Similar to 610, the AI manager may have some context information for the UEs from the second group and may select the UEs based on this context. The UEs from the second group may be associated with a trustworthy level (e.g., a trustworthy level less than that of the first group but still meeting minimum trustworthy requirements), or may not be associated with a trustworthy level.

In 630, the AI manager instructs each of the selected UEs from the second group to train and report respective AI/ML models.

In 635, the AI manager receives partial AI/ML models from the UEs of the second group and aggregates these partial models into a second version of a global model.

It should be understood that any number of stages of model training/refinement can be used by the AI manager. In one example, the second version of the global model described above can become the new “core” of the global model, and further versions of the global model can be interactively generated based on further partial models received from the UEs of further selected groups. It should be further understood that the method 600 of FIG. 6 can relate to federated learning operations.

### EXAMPLES

In a first example, a method performed by an artificial intelligence (AI) agent, comprising reporting a trained AI or machine learning (ML) (AI/ML) model to an AI manager, receiving feedback from the AI manager regarding a performance of the trained AI/ML model and based on the feedback, determining whether and how to improve a performance of the trained AI/ML model.

In a second example, the method of the first example, wherein the feedback comprises a performance result including an accuracy of the trained AI/ML model or a performance index of functionalities using the trained AI/ML model.

In a third example, the method of the first example, wherein the performance result comprises a percentage of correct inferences by the trained AI/ML model.

In a fourth example, the method of the first example, wherein the feedback comprises an indication of whether the AI agent can improve the trained AI/ML model.

In a fifth example, the method of the first example, wherein the feedback comprises an instruction to pause any further training of the AI/ML model and to gather additional data prior to further training the AI/ML model.

In a sixth example, the method of the first example, wherein the feedback comprises an instruction to stop any AI/ML model training tasks.

In a seventh example, the method of the first example, wherein the AI agent is a user equipment (UE) and the AI manager is a network node or network-side entity.

In an eighth example, the method of the first example, wherein the AI agent is a network node or network-side entity and the AI manager is a user equipment (UE).

In a ninth example, a processor configured to perform any of the methods of the first through eighth examples.

In a tenth example, a user equipment (UE) comprising a transceiver configured to communicate with a network and a processor communicatively coupled to the transceiver and configured to perform any of the methods of the first through eighth examples.

In an eleventh example, a network node comprising a transceiver configured to communicate with a user equipment (UE) and a processor communicatively coupled to the transceiver and configured to perform any of the methods of the first through eighth examples.

In a twelfth example, a method performed by an artificial intelligence (AI) manager, comprising receiving a trained AI or machine learning (ML) (AI/ML) model from an AI agent, evaluating a performance of the trained AI/ML model and providing feedback to the AI manager regarding the performance of the trained AI/ML model.

In a thirteenth example, the method of the twelfth example, wherein the feedback comprises a performance result including an accuracy of the trained AI/ML model or a performance index of functionalities using the trained AI/ML model.

In a fourteenth example, the method of the twelfth example, wherein the performance result comprises a percentage of correct inferences by the trained AI/ML model.

In a fifteenth example, the method of the twelfth example, wherein the feedback comprises an indication of whether the AI agent can improve the trained AI/ML model.

In a sixteenth example, the method of the twelfth example, wherein the feedback comprises an instruction to pause any further training of the AI/ML model and to gather additional data prior to further training the AI/ML model.

In a seventeenth example, the method of the twelfth example, wherein the feedback comprises an instruction to stop any AI/ML model training tasks.

In an eighteenth example, the method of the twelfth example, wherein the AI agent is a user equipment (UE) and the AI manager is a network node or network-side entity.

In a nineteenth example, the method of the twelfth example, wherein the AI agent is a network node or network-side entity and the AI manager is a user equipment (UE).

In a twentieth example, a processor configured to perform any of the methods of the twelfth through nineteenth examples.

In a twenty first example, a user equipment (UE) comprising a transceiver configured to communicate with a network and a processor communicatively coupled to the transceiver and configured to perform any of the methods of the twelfth through nineteenth examples.

In a twenty second example, a network node comprising a transceiver configured to communicate with a user equipment (UE) and a processor communicatively coupled to the transceiver and configured to perform any of the methods of the twelfth through nineteenth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of an artificial intelligence (AI) agent configured to perform operations comprising:
reporting a trained AI or machine learning (ML) (AI/ML) model to an AI manager;
receiving feedback from the AI manager regarding a performance of the trained AI/ML model; and
based on the feedback, determining whether and how to improve a performance of the trained AI/ML model.

2. The processor of claim 1, wherein the feedback comprises a performance result including an accuracy of the trained AI/ML model or a performance index of functionalities using the trained AI/ML model.

3. The processor of claim 2, wherein the performance result comprises a percentage of correct inferences by the trained AI/ML model.

4. The processor of claim 1, wherein the feedback comprises an indication of whether the AI agent improves the trained AI/ML model.

5. The processor of claim 1, wherein the feedback comprises an instruction to pause any further training of the trained AI/ML model and to gather additional data prior to further training the trained AI/ML model.

6. The processor of claim 1, wherein the feedback comprises an instruction to stop any AI/ML model training tasks.

7. The processor of claim 1, wherein the AI agent is a user equipment (UE) and the AI manager is a network node or network-side entity.

8. The processor of claim 1, wherein the AI agent is a network node or network-side entity and the AI manager is a user equipment (UE).

9. A processor of an artificial intelligence (AI) manager configured to perform operations comprising:
receiving a trained AI or machine learning (ML) (AI/ML) model from an AI agent;
evaluating a performance of the trained AI/ML model; and
providing feedback to the AI manager regarding the performance of the trained AI/ML model.

10. The processor of claim 9, wherein the feedback comprises a performance result including an accuracy of the trained AI/ML model or a performance index of functionalities using the trained AI/ML model.

11. The processor of claim 10, wherein the performance result comprises a percentage of correct inferences by the trained AI/ML model.

12. The processor of claim 9, wherein the feedback comprises an indication of whether the AI agent improves the trained AI/ML model.

13. The processor of claim 9, wherein the feedback comprises an instruction to pause any further training of the trained AI/ML model and to gather additional data prior to further training the trained AI/ML model.

14. The processor of claim 9, wherein the feedback comprises an instruction to stop any AI/ML model training tasks.

15. The processor of claim 9, wherein the AI agent is a user equipment (UE) and the AI manager is a network node or network-side entity.

16. The processor of claim 9, wherein the AI agent is a network node or network-side entity and the AI manager is a user equipment (UE).
